(19) United States
(12) Patent Application Publication
(10) Pub. No.: US 2009/0217259 A1
(43) Pub. Date: Aug. 27, 2009

(54) Building Operating System Images Based on Applications

(75) Inventors: Oren Winter, Kirkland, WA (US); Mohsen Moini, Bellevue, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/037,635

(22) Filed: Feb. 26, 2008

(51) Int. Cl. G06F 9/445

(52) U.S. Cl. 717/174

(57) ABSTRACT

Example systems and methods for creating an operating system image for an embedded device. In one example, the system includes an operating system base module including an operating system for the embedded device, a software application module, the software application module including one or more software applications that are programmed to execute on the embedded device, and an analysis program module programmed to identify dependencies in the one or more software applications. The system also includes a components module including one or more components that are added to the operating system base, and a mapping module programmed to map the dependencies to one or more components from the components module. Methods for creating an operating system image for an embedded device using an integrated development system are also described.

### BACKGROUND

Embedded devices are typically single application devices. In order for the application to work properly on the embedded device, the operating system of the embedded device must support all the features of the application. Many times, when an application is integrated into the operating system image for an embedded device, dependencies exist in the application that are not supported in the operating system image. For example, the application might need to render video and therefore need a system component, such as video player, to do so.

System components are typically added to the operating system image in an attempt to satisfy such dependencies. The process of adding needed system components to the operating system image and testing the built image to make sure that dependencies are satisfied is typically a trial and error approach that can make the build process long and tedious.

### SUMMARY

According to one embodiment, a system for creating an operating system image for an embedded device includes an operating system base module including an operating system for the embedded device, a software application module, the software application module including one or more software applications that are programmed to execute on the embedded device, and an analysis program module programmed to identify dependencies in the one or more software applications. The system also includes a components module including one or more components that are added to the operating system base, and a mapping module programmed to map the dependencies to one or more components from the components module.

According to another embodiment, an integrated development system for creating an operating system image for an embedded device includes an operating system base module including an operating system for the embedded device, and a software application module including one or more software applications that are provided in one or more formats. The system also includes an analysis program module including one or more analysis programs that are programmed to analyze the software applications to determine operating system dependencies in the software applications, a components module including one or more components that are programmed to be added to the operating system, a user interface module that permits the selection of the formats and the components, and a dependency processing module that executes the analysis programs to analyze the software applications and map the dependencies to the components that are displayed on the user interface.

According to yet another embodiment, a method for creating an operating system image for an embedded device using an integrated development system includes: identifying a software application to be executed on the base the operating system base; selecting a format for the software application from a user interface of the integrated development system; performing a dependency analysis on the software application using one or more analysis programs included in the integrated development system; determining operating system dependencies from the dependency analysis; mapping the dependencies to one or more components to be added to the operating system base; displaying the one or more components on the user interface; adding the selected components to the operating system base and adding the software application to the operating system base.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The accompanying drawings incorporated in and forming a part of the specification illustrate several aspects of the present disclosure, and together with the description serve to explain the principles of the disclosure. In the drawings:

FIG. 1 shows an example system for creating an operating system image for an embedded device.

FIG. 2 shows an example system for creating an operating system image for an embedded device using an integrated development system.

FIG. 3 shows an example user interface for a system for creating an operating system image for an embedded device using an integrated development system.

FIG. 4 shows a flow chart for an example method for creating an operating system image for an embedded device using an integrated development system.

### DETAILED DESCRIPTION

The present application is directed to systems and methods for building an operating system image for an embedded device. In examples described herein, the systems and methods use dependency analysis programs to determine operating system dependencies for one or more software applications running on the embedded device. Operating system components are identified that can be added to the operating system image to resolve these dependencies. The analysis programs can be run alone or as part of an integrated development system.

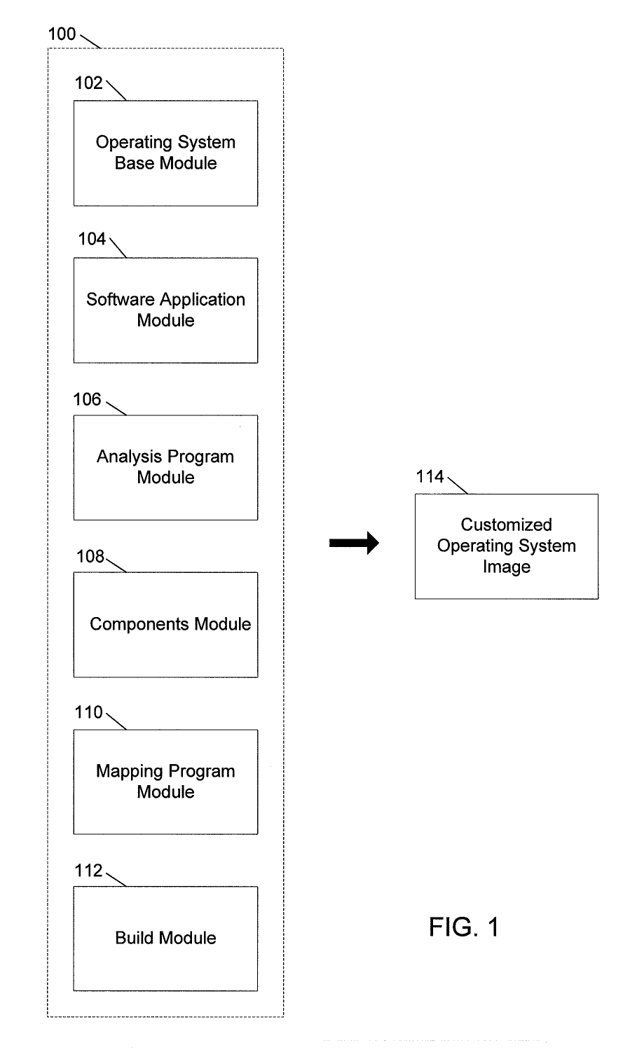

FIG. 1 shows an example system 100 used to build a customized operating system image on an embedded device. The example system 100 includes an operating system base module 102, a software application module 104, an analysis program module 106, a components module 108, a mapping module 110, and a build module 112. The end result of the build is a customized operating system image 114.

The example operating system base module 102 includes an operating system base used for embedded systems such as, for example, the WINDOWS® Embedded CE or XP Embedded operating systems provided by Microsoft Corporation of Redmond, Wash. Other operating systems can also be used. The operating system base is a shell of the full operating system that contains basic functions such as a kernel, a file system, core components, etc.

The software application module 104 includes one or more software applications that run on an embedded operating system such as, for example, a point-of-sale (POS) application that runs on a POS device. The software application module 104 may require support in the operating system from one or more system components. Such requirements are called dependencies. For example, the software application module 104 might require an audio capability which, in turn, would require the addition of a media component to the operating system base module 102. As described further below, some other example dependencies include, without limitation, a web browser used to render documents formatted in the hypertext markup language format, and a firewall used to limit connections to and from the embedded device.

To determine dependencies, the analysis program module 106 is programmed to analyze and identify the dependencies associated with the software application module 104. One example of such an analysis program is Dumpbin.exe, which is a command-line tool that can be used to identify the dependencies associated with the software application module 104. Dumpbin.exe analyzes the structure of binary files and dynamic link libraries. In another example, an analysis program such as Depends.exe, which is programmed to scan the software application module 104 and determine any dependencies associated with it that would prevent the software application from operating properly. Such analysis programs are typically static programs that can be run alone or within the context of an integrated development system, such as the VISUAL STUDIO® development system provided by Microsoft Corporation.

The dependencies in the software application that are discovered by the analysis program module 106 are mapped to operating system components that are used to resolve the dependencies. The components are included in example components module 108. The mapping is performed by mapping program module 110. Some examples of operating system components include a web browser such as: the INTERNET EXPLORER® internet browser provided by Microsoft Corporation; a media component such as the WINDOWS MEDIA® player; and a firewall component, such as Windows firewall. Other examples of components are possible.

The mapping program module 110 can be programmed to map the dependencies to the components by the can be accomplished using a variety of techniques. In some examples, the dependencies are mapped using lists, tables, databases or any other data structure. In the non-limiting example shown, a table is used to map the dependencies. One example table that can be used is a hash table that includes a data structure that associates keys with values. The hash table includes a list of possible dependencies, and maps the dependencies to one or more system components that meet the dependencies. Other configurations are possible.

The build module 112 is used to build an operating system image using the identified operating system components. The end result of this process is an operating system image 114 that satisfies the dependencies in the software application module 104. The customized operating system image 114 can be embedded in an embedded device, such as a POS device, to operate the device in a desired environment.

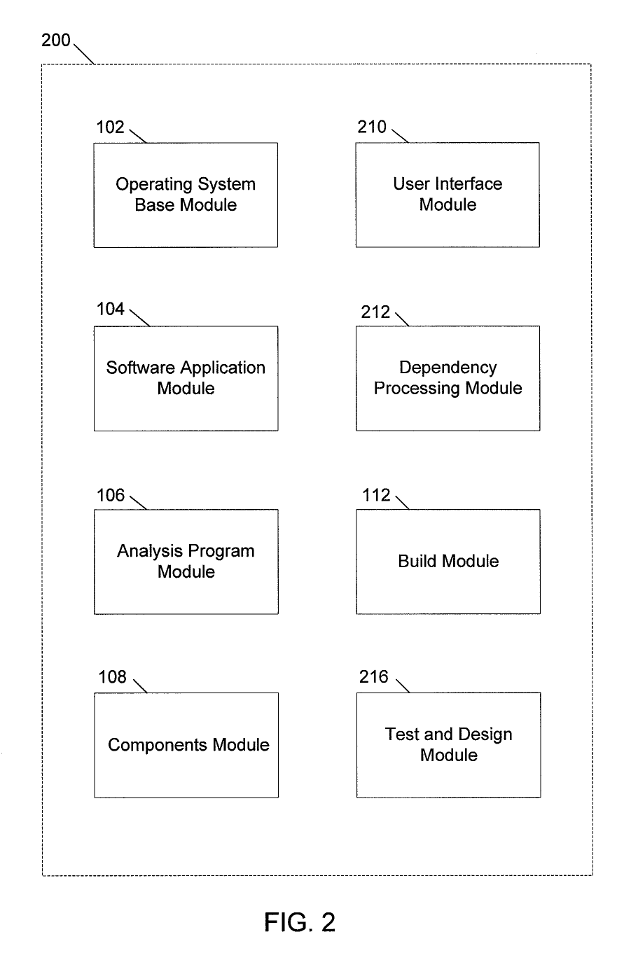

FIG. 2 shows an example integrated development system 200 that is used for building an operating system image for an embedded device. One example of such an example integrated development system is the VISUAL STUDIO® development system. Other tools can also be used. For example, in another example, the development system 200 is a stand-alone tool used to identify dependencies, map the dependences to system components, and/or create a customized operating system image, as described further below.

The integrated development system 200 includes the operating system base module 102, the software application module 104, the analysis program module 106, the components module 108, and the build module 112. The example integrated development system 200 also includes a user interface module 210, a dependency processing module 212, a build module 214, and a test and design module 216.

The example user interface module 210 generally permits the user to control identification of dependencies, mapping the dependences to system components, and creating a customized operating system image. For example, the user interface module 210 permits a user to select a format for the software application module 104. One of several formats can be selected including a binary file, a source code file, and an install file. The example user interface module 212 also provides a display of components that can be added to the operating system base module 102.

The example dependency processing module 212 runs the one or more analysis programs on a software application, identifies operating system dependencies in the software application, and maps the dependencies into operating system components that resolve these dependencies. In some embodiments, the dependency and processing module 212 automatically adds the identified operating system components to a list of operating system components and builds a new operating system image based on these components. In other embodiments, the identified components are presented to a user via the user interface module 210 and the user selects the components to be added.

Once the user selects components to be added to the operating system base module 102, the build module 214 is used to build the operating system image. The built operating system image is then tested by the test and design module 216 to determine if any additional dependencies exist in the operating system. The test and design module 216 includes analysis programs that analyze the operating system image created by the build module 112. Because the operating system image can include both software and hardware dependencies, the test and design module 216 can be programmed to discover new dependencies that the dependency processing module 212 may have missed.

The example test and design module 216 identifies any new operating system dependencies and also identifies operating system components that can resolve these dependencies. In some embodiments, the test and design module 216 automatically adds the identified operating system components to a list of operating system components and builds a new operating system image based on these components. In other embodiments, the identified components are presented to a user via the user interface module 210 and the user selects the components to be added.

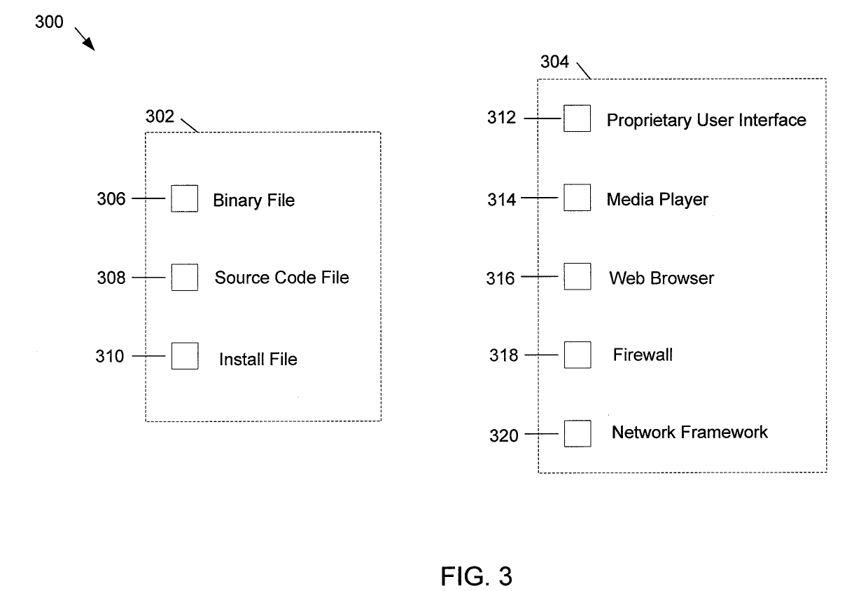

An example user interface 300 generated by the user interface module 210 is shown in FIG. 3. The example user interface 300 includes a section 302 for selecting the format of the software application, and a section 304 for selecting components.

The example section 302 includes checkboxes for selecting the file format of a software application. Included is a checkbox 306 for a binary file format, a checkbox 308 for a source file format and a checkbox 310 for an install file format.

The example components section 304 includes checkboxes for selecting system components to satisfy dependencies. In the example shown, the components section 304 lists such components as: a proprietary user interface 312 such as, for example, the WINDOWS® XP operating system interface provided by Microsoft Corporation; a checkbox 314 for a media player; a checkbox 316 for a web browser; a checkbox 318 for a firewall; and a checkbox 320 for network framework such as, for example, the .Net framework provided by Microsoft Corporation. Other components are possible.

In example embodiments, one or more checkboxes in the section 304 may be automatically checked by the integrated development system 200 to select the components identified by the dependency processing module 212 to resolve dependencies in the software application. In addition to the automatic checking, the user may select additional components by manually checking one or more of the checkboxes in the section 304.

In example embodiments, the systems 100, 200 and the user interface 300 are implemented on one or more computer systems. In example embodiments, the systems 100, 200 include a processing unit and computer readable media. The computer readable media can include memory such as volatile (such as RAM), non-volatile (such as ROM, flash memory, etc.) or some combination thereof. The systems 100, 200 can include mass storage (removable and/or non-removable) such as a magnetic or optical disks or tape. An operating system and one or more application programs can be stored on the systems 100, 200. Other configurations are possible.

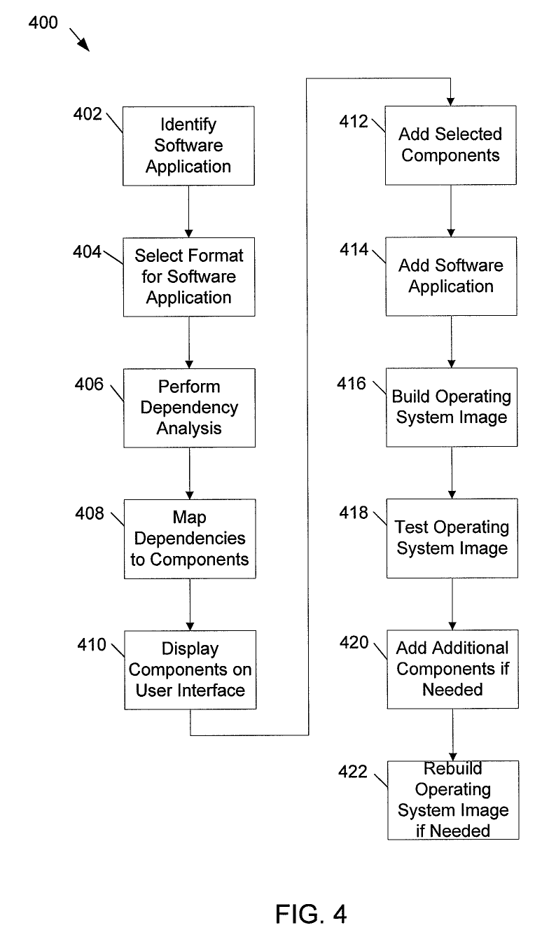

FIG. 4 is a flowchart illustrating an example method 400 for creating an operating system image for an embedded device using an integrated development system. As described above, the integrated development system is generally used to build operating system images for a specific embedded operating system platform.

Initially, at operation 402 of the method 400, a software application is identified for adding to the operating system platform. This may be done, for example, by opening a project file in the example integrated development system and selecting a software application. At operation 404, the file type for the software application is selected such as, for example, a binary file, a source code file or an install file. The selection may be done on the user interface of the integrated development system by selecting a checkbox corresponding to the appropriate file type. Alternate methods of selection are possible such as, for example by using a project file in the integrated development system.

In other examples, the user can select other parameters as well. For example, in some embodiments, the integrated development system is programmed to handle multiple types of operating systems, such as the WINDOWS® Embedded CE or XP Embedded operating systems. In such an example, the user can select which operating system is desired prior to the analysis of the software application.

At operation 406, one or more analysis programs included in the integrated development system are run against the software application to determine if there are any operating system dependencies in the software application. At operation 408, the identified dependencies are mapped to operating system components that are used to resolve the dependencies.

The identified operating system components are then displayed on the user interface of the integrated development system at operation 410. The integrated development system may display the identified components, for example, by checking a checkbox for the component on the user interface. At operation 412, the user chooses to accept the identified components, deselect a component or manually select additional components. Once the user is satisfied with the selection, the software application is added to the operating system base at operation 414 and the operating system image is built at operation 416.

At operation 418, the built image is tested to determine if additional dependencies exist. For example, the integrated development system may include additional test and analysis programs that test the build operating system image from the standpoint of the operating system hardware. The test and analysis programs may identify additional components that may be added to further adjust the operating system image. At operation 420, these additional components may be added to the operating system image. The addition of these components may be done automatically may the integrated development system or may be added manually by the user. Finally, at operation 422, if additional components are added, the operating system image is rebuilt on the integrated development system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for creating an operating system image for an embedded device, the system comprising:
an operating system base module including an operating system for the embedded device;
a software application module, the software application module including one or more software applications that are programmed to execute on the embedded device;
an analysis program module programmed to identify dependencies in the one or more software applications;
a components module including one or more components that are added to the operating system base; and
a mapping module programmed to map the dependencies to one or more components from the components module.

2. The system of claim 1, wherein the components are selected from a group consisting of: a media player, a web browser, and a firewall.

3. The system of claim 1, wherein the mapping module is further programmed to map the dependencies using a hash table.

4. The system of claim 1, further comprising a user interface programmed to include a first section for selecting a format of the software application, and a second section for selecting the components.

5. The system of claim 1, further comprising a build module that builds an operating system image.

6. An integrated development system for creating an operating system image for an embedded device, the integrated development system comprising:
an operating system base module including an operating system for the embedded device;
a software application module including one or more software applications that are provided in one or more formats;
an analysis program module including one or more analysis programs that are programmed to analyze the software applications to determine operating system dependencies in the software applications;
a components module including one or more components that are programmed to be added to the operating system;
a user interface module that permits the selection of the formats and the components; and
a dependency processing module that executes the analysis programs to analyze the software applications and map the dependencies to the components that are displayed on the user interface.

7. (canceled)

8. The system of claim 6, wherein the components are selected from a group consisting of: a media player, a web browser, and a firewall.

9. (canceled)

10. The system of claim 6, further comprising a build module that builds an operating system image.

11. The system of claim 10, further comprising a test and design module that tests the operating system, determines additional dependencies in the operating system, and selects components to resolve the additional dependencies.

12. The system of claim 6, further comprising a mapping module programmed to map the dependencies using a hash table.

13. A method for creating an operating system image for an embedded device using an integrated development system, the method comprising:
identifying a software application to be executed on an operating system base;
selecting a format for the software application from a user interface of the integrated development system;
performing a dependency analysis on the software application using one or more analysis programs included in the integrated development system;
determining operating system dependencies from the dependency analysis;
mapping the dependencies to one or more components to be added to the operating system base;
displaying the one or more components on the user interface;
adding the selected components to the operating system base; and
adding the software application to the operating system base.

14. The method of claim 13, wherein mapping the dependencies further comprises mapping the dependencies using a hash table.

15. The method of claim 13, wherein the components are selected from a group consisting of: a media player, a web browser, and a firewall.

16. The method of claim 13 further comprising permitting a user to manually deselect mapped components and to select additional components.

17. The method of claim 13, further comprising building an operating system image from the operating system base.

18. The method of claim 13, further comprising testing the operating system base to determine if any additional dependencies exist.

19. The method of claim 18, further comprising adding additional components to the operating system base to resolve the dependencies.

20. The method of claim 19, wherein mapping the dependencies further comprises mapping the dependencies using a hash table.
